(19) United States
(12) Patent Application Publication
(10) Pub. No.: US 2009/0001006 A1
(43) Pub. Date: Jan. 1, 2009

(54) INTEGRATED SUCTION AND DRAINING DEVICE FOR THE TANK OF A DISHWASHING MACHINE AND DISHWASHING MACHINE INCLUDING SUCH A DEVICE

(76) Inventor: Gianluca Pardini, Lucca (IT)

Correspondence Address: THOMPSON HINE LLP;Intellectual Property Group, P.O Box 8801, DAYTON, OH, 45401-8801, US

(21) Appl. No.: 12/163,129

(22) Filed: Jun. 27, 2008

(30) Foreign Application Priority Data
Jun. 29, 2007 (IT) TO2007A000475

(51) Int. Cl. B01D 35/30; C02F 9/08

(52) U.S. Cl. 210/195.4; 210/248; 210/232

(57) ABSTRACT

An integrated device including an overflow tube and a cup-shaped body filtering element concentrically mounted to the overflow tube; wherein the overflow tube presents a first end connected to a draining tube and a second blank end, opposite to the first, which overhangingly protrudes upwards inside a tank of a washing compartment of a dishwashing machine, the second end of the overflow tube presenting at least one side opening essentially arranged in use at the surface height of a head of washing fluid inside the tank; the filtering element being arranged with a first laterally blank end thereof so as to shield the at least one side opening of the overflow tube, while a second end thereof is provided with a plurality of openings made so as to define a filtering mesh at a bottom wall of the tank and around the overflow tube, in a position immediately facing a suction sump arranged underneath the tank and within which the first end of the overflow tube projects.

### TECHNICAL FIELD

The present application relates to an integrated suction and draining device for a collection tank of a washing fluid of a dishwashing machine, in particular of a dishwashing machine for professional use, in which at least part of the washing fluid is recirculated.

### BACKGROUND

It is known that dishwashing machines, in particular those for professional use (for bars, restaurants, communities, etc.), include a washing compartment interiorly delimited by a waste washing fluid collection tank, with an overflow tube to maintain the level of the washing fluid in the tank constant, allowing the uppermost part of the same to be conducted to the drain. A suction sump is also arranged underneath the tank, from which sump the feeding pump of spraying means of the washing fluid draws the washing fluid so that washing fluid is at least partly recirculated. Unfortunately, while the uppermost part of the waste washing fluid consists of the hottest and cleanest part of the same, the washing fluid inside the suction sump tends to be the dirtiest and the coldest, which produces a square energy loss.

In order to solve this drawback, EP-A-0333251 proposes to use a siphon device with opening underneath the surface height of the water for draining the exceeding washing fluid in the tank, as also known from U.S. Pat. No. 3,174,489.

However, the proposed solutions are relatively expensive and/or complex to be implemented, and/or excessively cumbersome. Furthermore, in order to avoid the risk of obstructing the draining and suction pipes it is necessary to include filtering elements in the tank, which are capable of blocking at least the larger sized contaminants (e.g. food residues), which filtering elements, however, may form areas in the tank which are difficult to be cleaned.

It would be desirable to provide an integrated suction and draining device for a tank of a dishwashing machine which is at the same time reliable, compact, simple, relatively cost-effective and/or which does not cause the formation of areas which are difficult to be cleaned.

### SUMMARY

In one aspect, a dishwashing machine includes an overflow tube and a filtering element. The filtering element is a cup-shaped body concentrically mounted to the overflow tube and the latter presents a first end connectable in use to a draining tube and a second blank end, opposite to the first, designed to overhangingly protrude in use upwards, inside the tank, and presenting at least one side opening intended to be essentially arranged in use at the surface height of a head of washing fluid inside the tank. The filtering element is further arranged with a first laterally blank end thereof shielding the mentioned at least one side opening of the overflow tube, while a second end thereof, opposite to the first, is provided with a plurality of first openings made so as to define a first filtering mesh arranged around the overflow tube and underneath the second end of the latter.

Furthermore, the second end of the filtering element is adapted, in use, to couple in a substantially fluid-tight manner with a bottom wall of the tank and with a suction sump arranged underneath the tank and into which the first end of the overflow tube protrudes.

The suction sump is formed as an element independent of, but couplable with, the bottom wall of the tank, and is cup-shaped, comprising a bottom wall and a side wall which defines, on the side opposite to the bottom wall, a flanged coupling mouth of the suction sump with the bottom wall of the tank. The bottom wall of the suction sump supports the first end of the overflow tube driven therein, so that the latter extends perpendicularly and overhangingly from the bottom wall of the suction sump and through the mouth of the same into the tank.

The device includes a fastening ring nut of the suction sump to the bottom wall of the tank which is removably couplable against the bottom wall of the tank, on the side opposite to that facing the flanged mouth and on the latter so that, in use, the bottom wall of the tank is sandwiched between the ring nut and the flanged mouth of the suction sump.

In this manner, a device which is compact, cost-effective and/or easy to be implemented and fitted is obtained, because it uses a single filtering element both for draining and for suction and which allows to obtain, on one hand, the protection of the pump from possible blockages caused by objects dropped into the tank, to avoid the obstruction of the washing nozzles and of the drain and, on the other hand, to obtain a ‘siphon effect’ which avoids wastages of energy allowing to drain the coldest and dirtiest washing water, thus subtracting it from recirculation. Furthermore, in virtue of its extremely linear and symmetric structure, it does not create any area which is difficult to be cleaned in the tank.

### BRIEF DESCRIPTION OF THE DRAWINGS

Further objects and advantages will be apparent from the following description of a non-limitative embodiment thereof, provided only by way of example, with reference to the accompanying drawings, in which:

FIG. 1 diagrammatically shows an elevational, longitudinal section view of one embodiment of a dishwashing machine equipped with a suction and draining device;

FIG. 2 shows an elevational, longitudinal section view of the device according to the invention;

FIG. 3 shows an exploded, section view of the device in FIG. 2;

FIG. 4 shows a perspective, diagrammatic view on enlarged scale of the device in FIGS. 2 and 3 and of the main components of the dishwashing machine in FIG. 1; and

FIG. 5 shows on an enlarged scale a perspective, partial section view of a constructional detail of the device.

### DETAILED DESCRIPTION

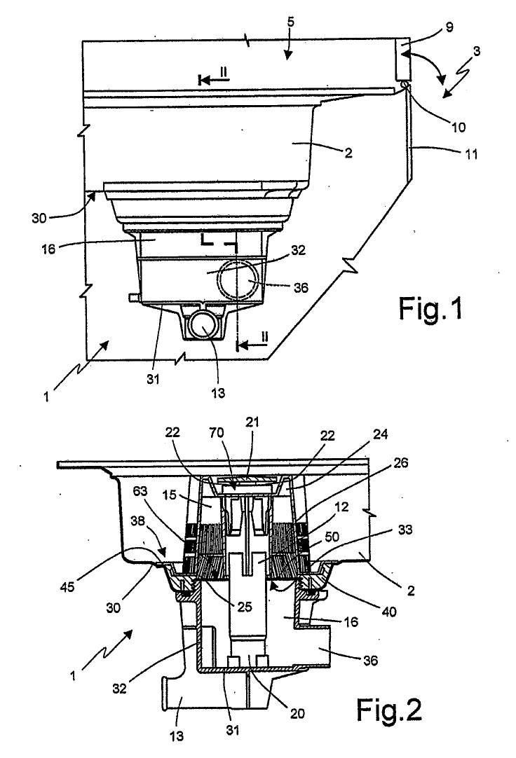

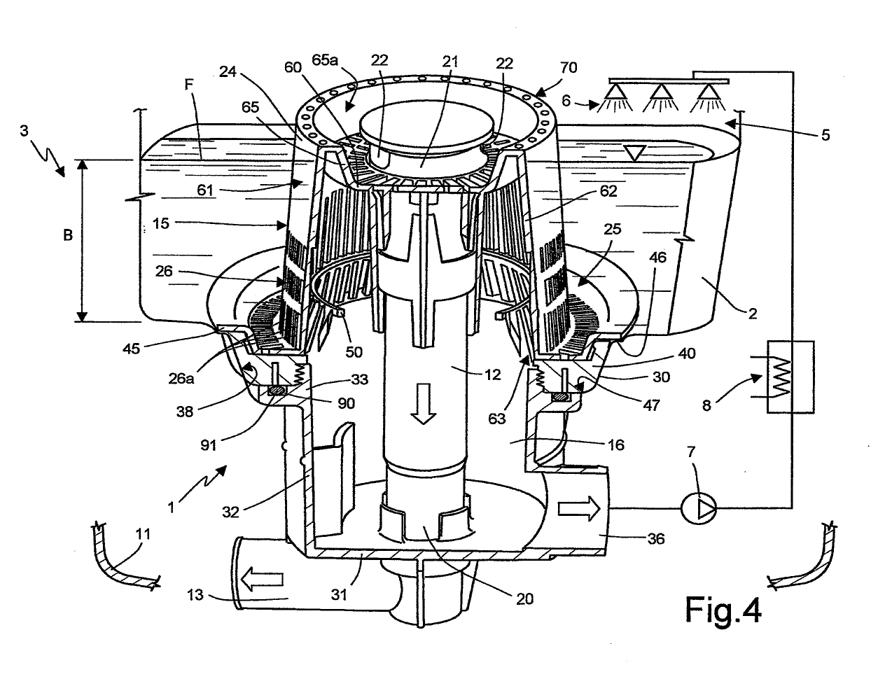

In figures from 1 to 5, numeral 1 indicates as a whole an integrated suction and draining device for a tank 2 of a dishwashing machine 3, of the type in which at least part of a washing fluid F is recirculated in use. A washing compartment 5 extends downward to the lower collection tank 2 for the washing fluid F, fed in use into the compartment 5 by means of a known spraying means 6 (e.g., one or more spray nozzles located in a moving or stationary wash arm) from a pump 7. The washing compartment is accessible from the outside in a known manner through a tilting door 9 about a horizontal rotation axis 10 (FIGS. 1 and 4). The entire assembly consisting of the washing compartment 5, the tank 2, the sprayer means 6, the pump 7 and other functional elements of the dishwasher 3, e.g. heating means 8 for the washing fluid F arranged upstream of the spraying means 6, is enclosed in a containing and supporting casing 11, supporting the door 9.

The tank 2 is provided with an overflow tube 12 hydraulically connected to a draining tube 13 for the waste washing fluid F, with at least one filtering element 15 and with a suction sump 16 in hydraulic communication therewith and, in use, with the feeding pump 7 of the washing fluid F to the spraying means 6 arranged in the washing compartment 5.

A single filtering element 15, which is shared by the tube 12 and the suction sump 16, is present in the tank 2. Filtering element 15 is a cup-shaped body and concentrically mounted to the overflow tube 12. The tube presents a first end 20 connectable in use to a draining tube 13 and a second blank end 21, opposite to the first, designed to overhangingly protrude in use upwards, inside the tank 2, and presenting at least one side opening 22 (in the shown case, two reciprocally and diametrically opposite slot-shaped side openings 22) intended to be essentially arranged in use (FIG. 4) at the surface height of a head B of washing fluid F inside the tank.

The filtering element 15 is arranged with a first laterally blank end 24 shielding the side openings 22 of the overflow tube 12, while a second end 25 thereof, opposite to the first, is provided with a plurality of first openings 26a (FIG. 4) made so as to define a first filtering mesh 26 arranged in use around the overflow tube 12 and lower than the second end 21 thereof, in a position immediately facing the sump 16.

The second end 25 of the filtering element 15 is shaped to be adapted, in use, to couple in a substantially fluid-tight manner with a bottom wall 30 of the tank 2 and, accordingly, with the suction sump 16, arranged underneath the tank 2 and inside which, in use, the end 20 of the overflow tube 12 protrudes.

The suction sump 16 is an integral part of the device 1 and is formed as an element independent of, but couplable with, the bottom wall 30 of the tank 2. The sump 16 is cup-shaped, comprising a bottom wall 31 and a side wall 32 which defines, on the side opposite to the bottom wall 31, a flanged mouth 33 coupling the suction sump 16 to the bottom wall 30 of the tank 2.

The bottom wall 31 of the suction sump 16 supports in use the end 20 of the overflow tube 12 driven therein, so that the latter extends perpendicularly and overhangingly from the bottom wall 31 of the suction sump 16 and through the mouth 33 of the same into the tank 2.

The bottom wall 31 of the suction sump 16 is integrally provided in one unitary piece with the draining tube 13, which is obtained so as to be hydraulically connected in use to the first end 20 of the overflow tube 12; while the side wall 32 of the suction sump 16 is laterally and protrudingly provided, on the outside, with a suction tube 36 connectable in use to the feeding pump 7 of the washing fluid F in the washing compartment 5 of the dishwashing machine 3. In particular, the suction sump 16 is completely obtained in a single unitary piece along with the tubes 13 and 36, by moulding a synthetic plastic material. The filtering element 15 may also formed by integrally moulding a synthetic plastic material.

The device 1 also includes an accommodation seat 38 for the suction sump 16 obtained through the bottom wall 30 of the tank 2 and a fastening ring nut 40 for the suction sump 16 to the bottom wall 30 of the tank 2, which is removably couplable against the bottom wall 30 itself, on the side opposite to the flanged mouth 33 and on the latter so that, in use, the bottom wall 30 of the tank 2 is sandwiched between the ring nut 40 and the flanged mouth 33 of the suction sump 16.

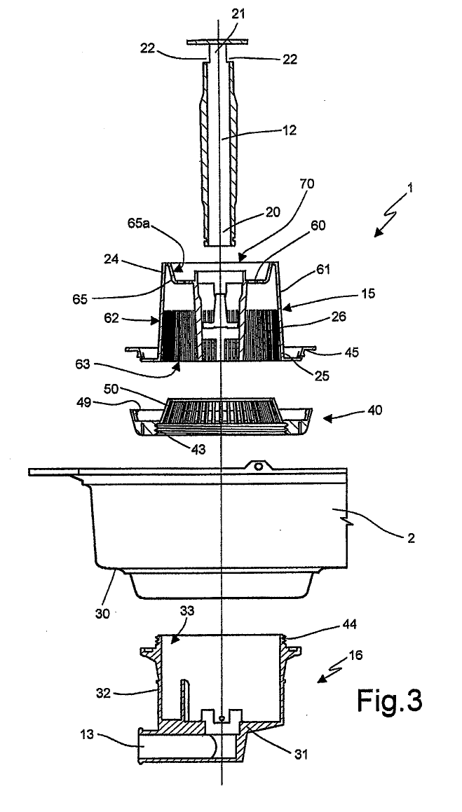

In particular, the ring nut 40 is also formed by moulding a synthetic plastic material and both the ring nut 40 and the mouth 33 are provided with corresponding threaded portions 43 and 44 (FIG. 3) reciprocally couplable by screwing.

In turn, the filtering element 15 is in use snappingly and integrally coupled to the ring nut 40, on the side opposite to the flanged mouth 33, by means of a flanged ring 45 integrally, axially and radially carried on the outside by the end 25 of the filtering element 15. The flanged ring 45 is adapted in use to abuttingly couple against the bottom wall 30 of the tank 2 upon coupling the ring nut 40 onto the flanged mouth 33 of the suction sump.

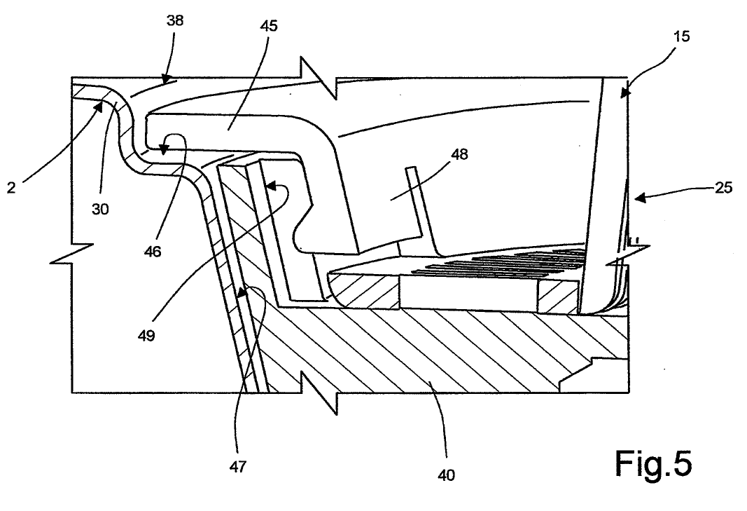

In particular, the accommodation seat 38 obtained through the bottom wall 30 of the tank 2 comprises (FIGS. 4 and 5) a first peripherally more external, annular, shallow recess 46 which is adapted to receive the flanged ring 45 therein, and a second shallow recess 47, deeper than the first, adapted to receive the ring nut 40 therein.

As shown in FIG. 3, the flanged ring 45 is axially and integrally coupled to the end 25 of the filtering element 15 so as to allow the adjustment of the axial position of the filtering element 15 itself relative to the overflow tube 12, e.g. it is screwed to the end 25 with micrometric adjustment. In any case, the ring 45 is snappingly coupled to the end 25 by means of elastically deformable teeth 48 (FIG. 5) which snap into radial seats 49 carried by an upper peripheral socket-shaped edge of the ring nut 40.

The ring nut 40 is further integrally provided, on opposite side to the suction sump 16, with a laterally perforated truncated-cone-shaped socket 50 which protrudes in use into the end 25 of the filtering element 15 so as to be interposed between this and the overflow tube 12.

The end 24 of the filtering element 15 axially protrudes, parallelly to the overflow tube 12, beyond the second end 21 of the latter provided with openings 22. In particular, the end 24 of the cup-shaped body filtering element 15 defines a bottom wall 60 and an upper part 61 of a side wall 62 of the same, while the end 25 of the filtering element 15 defines the remaining (lower) part of the side wall 62 and delimits a mouth 63 opposite to the bottom wall 60 and facing in use the suction sump 16 and the mouth 33 of the latter.

The bottom wall 60 of the filtering element 15 is provided in axis with the overflow tube 12 and towards the latter with a truncated-cone-shaped boss 65 which extends into the end 24 to define, on the outside of the filtering element 15, a shallow recess 65a in which the openings 22 of the overflow tube 12 faces in use. The bottom wall 60 of the filtering element 15 is further provided, both through a peripheral edge of the same and through the boss 65, with a plurality of second openings made so as to define a second filtering mesh 70 aimed to reject, along with the blank end 21 of the tube 12, which is therefore mushroom-shaped so as to couple in use near the peripheral edge of the ends 24, possible contaminants (e.g. food residues) which could accidentally come in contact with the top of the filtering element 15.

Finally, in order to ensure the fluid-tightness of the washing fluid F, the flanged mouth 33 is peripherally provided on the outside and towards the ring nut 40 with an annular seat 90 for a sealing ring 91 intended to couple against the bottom wall 30 of the tank 2 on side opposite to the ring nut 40 and at the same (FIG. 4).

According to the description, it is apparent that the filtering element 15, in virtue of the special structure of the device 1, serves in use as filter both during the step of draining, towards the overflow tube 12, and during the step of suction, when the pump 7 aspirates the washing fluid F from the tank 2 through the sump 16 underneath. Furthermore, the draining tubes 12 and 13 and the suction tube 36 are compactly integrated in a single element (precisely, the sump 12) thus reducing the volume and simplifying the assembly inside the device.

1. An integrated suction and draining device for a tank of a dishwashing machine, comprising an overflow tube and a filtering element; characterised in that the filtering element is a cup-shaped body concentrically mounted with respect to the overflow tube; the overflow tube having a first end connectable in use to a draining tube and a second blank end, opposite to the first, designed to overhangingly protrude in use upwards, inside said tank, and having at least one side opening essentially arranged in use at the surface height of a head of washing fluid present inside the tank; said filtering element being arranged with a first laterally blank end so as to shield said at least one side opening of the overflow tube, while a second end thereof, opposite the first, is provided with a plurality of first openings made so as to define a first filtering mesh arranged in use around the overflow tube and lower than the second end of the overflow tube; said second end of the filtering element being adapted, in use, to couple in a substantially fluid-tight manner with a bottom wall of the tank in a position immediately facing a suction sump arranged underneath the tank and inside which the first end of the overflow tube protrudes.

2. A device according to claim 1, characterised in that said suction sump, which is formed as an element independent of, but couplable with, said bottom wall of the tank, and is cup-shaped, comprises a bottom wall and a side wall which defines, on the side opposite to the bottom wall, a flanged mouth coupling the suction sump to the bottom wall of the tank; the bottom wall of the suction sump supporting said first overflow tube end driven therein, so that the overflow tube extends perpendicularly from the bottom wall of the suction sump and through the mouth of the suction sump into the tank.

3. A device according to claim 2, characterised in that said bottom wall of said suction sump is integrally provided in one unitary piece with said draining tube, which is arranged so as to be hydraulically connected to said first end of the overflow tube; while said side wall of the suction sump is laterally and protrudingly provided, on the outside, with a suction tube connectable in use to a feeding pump that delivers the washing fluid to a washing compartment of the dishwashing machine.

4. A device according to claim 2, characterised in that an accommodation seat for said suction sump is obtained through said bottom wall of the tank; and a fastening ring nut of the suction sump to the bottom wall of the tank removably couplable against the bottom wall of the tank, on the side opposite to that facing said flanged mouth and on the latter so that, in use, the bottom wall of the tank is sandwiched between said ring nut and said flanged mouth of the suction sump.

5. A device according to claim 4, characterised in that said flanged mouth of the suction sump and said ring nut are provided with corresponding threaded portions reciprocally couplable by screwing.

6. A device according to claim 4, characterised in that said filtering element is snappingly and integrally coupled to said ring nut, on the side opposite to the flanged mouth, by means of a flanged ring integrally, axially and radially carried on the outside by said second end of the filtering element; said flanged ring being adapted in use to abuttingly couple against said bottom wall of the tank in consequence of the coupling of said ring nut to said flanged mouth of the suction sump.

7. A device according to claim 6, characterised in that said accommodation seat obtained through the bottom wall of the tank comprises a first peripherally more external annular shallow recess, adapted to receive said flanged ring therein, and a second shallow recess, deeper than the first, adapted to receive there within said ring nut.

8. A device according to claim 6, characterised in that said flanged ring is coupled axially integral with said second end of the filtering element so as to allow the adjustment of the axial position of the filtering element relative to said overflow tube.

9. A device according to claim 4, characterised in that said ring nut is integrally provided, on opposite side to said suction sump, with a truncated-cone-shaped socket laterally perforated and which protrudes within the second end of the filtering element so as to be interposed between this and said overflow tube.

10. A device according to claim 1, characterised in that said first end of the filtering element axially protrudes, parallelly to the overflow tube, beyond said second end of the overflow tube.

11. A device according to claim 1, characterised in that said first end of said cup-shaped body filtering element defines a bottom wall and a part of a side wall of the same, while said second end of the filtering element defines the remaining part of the side wall and delimits a mouth opposite to the bottom wall and facing in use said suction sump.

12. A device according to claim 11, characterised in that said bottom wall of the filtering element is provided in axis with the overflow tube and towards the latter with a truncated-cone-shaped boss which extends inside the first end of the filtering element to define, on the outside of the filtering element, a shallow recess in which said at least one side opening of the overflow tube faces; said bottom wall of the filtering element being provided, both through a peripheral edge of the same and through said boss, with a plurality of second openings made so as to define a second filtering mesh.

13. A dishwashing machine of the type in which a least part of a washing fluid is recirculated in use, comprising a washing compartment with a collection tank for the washing fluid, the tank being provided with an overflow tube hydraulically connected to a draining tube for the waste washing fluid, at least one filtering element and a suction sump in hydraulic communication with the collection tank and with a feeding pump of the washing fluid to spraying means arranged in the washing compartment; characterised in that said filtering element is a cup-shaped body mounted concentrically with respect to the overflow tube; the overflow tube presenting a first end connected to said draining tube and a second end, blank and opposite the first, which overhangingly protrudes, from the bottom upwards, inside the tank, and presents at least one side opening essentially arranged in use at the surface height of a head of washing fluid present inside the tank; the filtering element being arranged with a laterally blank first end so as to shield said at least one side opening of the overflow tube, while a second end of the filter element is provided with a plurality of openings made so as to define a filtering mesh arranged around the overflow tube and lower than the second end of the overflow tube; said second end of the filtering element being adapted, in use, to essentially fluid-tightly couple with a bottom wall of the tank and with said suction sump, which suction sump is arranged underneath the tank and inside which the first end of the overflow tube projects.

14. An integrated suction and draining device for a tank of a dishwashing machine, comprising an overflow tube and a filtering element; characterised in that:
the filtering element is a cup-shaped body concentrically mounted with respect to the overflow tube; the overflow tube having a first end connected to a draining tube and a second end, opposite to the first end, protruding upwards, inside said tank, and having at least one side opening located at a height of a surface of washing fluid present inside the tank; said filtering element arranged with a first laterally enclosing end so as to shield said at least one side opening of the overflow tube, while a second end of the filtering element, opposite the first end of the filtering element, is provided with a plurality of first openings made so as to define a first filtering surface arranged in use around the overflow tube and lower than the second end of the overflow tube; said second end of the filtering element being coupled in a substantially fluid-tight manner with a bottom wall of the tank in a position facing a suction sump arranged underneath the tank and inside which the first end of the overflow tube protrudes.

15. A device according to claim 14, characterised in that said suction sump is formed as an element independent that is coupled to said bottom wall of the tank, said suction sump is cup-shaped and comprises a bottom wall and a side wall, the side wall defines a flanged mouth coupling the suction sump to the bottom wall of the tank; the bottom wall of the suction sump supports said first overflow tube end, so that the overflow tube extends perpendicularly from the bottom wall of the suction sump and through the mouth of the suction sump into the tank.

16. A device according to claim 14, characterised in that said first end of the filtering element axially protrudes, parallelly to the overflow tube, beyond said second end of the overflow tube.

17. A device according to claim 14, characterised in that said first end of said cup-shaped body filtering element defines a bottom wall and a part of a side wall of the same, while said second end of the filtering element defines the remaining part of the side wall and delimits a mouth opposite to the bottom wall and facing said suction sump.
